(19) United States
(12) Patent Application Publication
(10) Pub. No.: US 2009/0327640 A1
(43) Pub. Date: Dec. 31, 2009

(54) METHOD FOR EXPANDING LOGICAL VOLUME STORAGE SPACE

(75) Inventors: Hai-Ting YAO, Tianjin (CN); Tom CHEN, Taipei (TW)

Correspondence Address: Workman Nydegger;1000 Eagle Gate Tower, 60 East South Temple, Salt Lake City, UT, 84111, US

(73) Assignee: INVENTEC CORPORATION, Taipei (TW)

(21) Appl. No.: 12/270,021

(22) Filed: Nov. 13, 2008

(30) Foreign Application Priority Data
Jun. 27, 2008 (TW) 097124381

(51) Int. Cl. G06F 12/02; G06F 12/00

(52) U.S. Cl. 711/170; 711/E12.001; 711/E12.002

(57) ABSTRACT

A method for expanding a logical volume (LV) storage space includes creating an LV by using an LV manager, and allocating a storage space for the LV according to a certain proportion; reserving a continuous expanding space behind the allocated storage space; determining in real time whether the LV storage space needs to be expanded or not during a data writing process till the data has been completely written; if the LV storage space needs to be expanded, obtaining a size of a new expanding space required to be reserved by calculating an increment coefficient of space expansion according to a using situation of the previously reserved expanding space, thereby further reserving a continuous expanding space within a space scope managed by the LV manager; and if the LV storage space does not need to be expanded, directly writing the data.

### CROSS-REFERENCE TO RELATED APPLICATIONS

This non-provisional application claims priority under 35 U.S.C. § 119(a) on Patent Application No(s). 097124381 filed in Taiwan, R.O.C. on Jun. 27, 2008 the entire contents of which are hereby incorporated by reference.

### BACKGROUND OF THE INVENTION

1. Field of the Invention

The present invention relates to a method for expanding a logical volume (LV) storage space, and more particularly to a method for dynamically and continuously expanding an LV storage space as data is continuously written into the LV.

2. Related Art

A logical volume management (LVM) provides a higher level and high-efficient manner for managing a storage space of a system disk, which is different from a conventional space partition management manner of disk partitions. In brief, the volume built through the LVM management manner may easily adjust a storage medium without damaging the existing data, and once a new hard disk is added, the new hard disk space is immediately combined with the original volume, so as to be used directly. The LVM provides a perfect storage space environment for the operations of a large-scale database, and the LVM may also be used in a common system management, which can more effectively manage the available spaces allocated by the system.

Recently, with the rapid development of the data storage technique, the LVM technique has been increasingly widely applied. The LVM can manage a plurality of storage devices in a united manner, for example, physical disks or redundant arrays of inexpensive disks (RAID) devices to form a volume group (VG), and the subscriber divides a LV with a designated size in the VG for usage. The physical disk or the RAID device used in the VG is called a physical volume (PV). One LV may merely occupy a part of one storage device or span across a plurality of storage devices, and the size of the storage space may be appropriately adjusted. Therefore, it is quite flexible in terms of space utilization, so as to realize a virtualization of the storage device.

One working manner of the LVM is briefly described below. Each PV is partitioned into several basic units, i.e., so-called physical extents (PEs). In each PV, each PE has one unique identification (ID) number. PE is the minimum storage unit in one physical storage device that can be addressed by the LVM. Each LV may also be partitioned into some addressable basic units, i.e., so-called logical extents (LEs). In the same VG, the size of the LE is the same as that of the PE, and apparently, the size of the LE is the same for all the LVs in one VG. In one PV, each PE has one unique ID number, but it is not necessary for the LV. The reason lies in that, when the ID numbers of the PEs cannot be used, the LV may be formed by some PVs. Therefore, the ID number of the LE is used to identify the LE and relevant specific PE. As described above, the LE and the PE are corresponding to each other one by one. Each time when the storage area is addressed and accessed, or the ID number of the LE is used, the data is written to the physical storage device.

Where are all the metadata relevant to the LV and the LV group stored? Similarly, in a non-LVM system, the data relevant to the partition is stored in a partition table, and the partition table is stored at an initial position of each PV A volume group descriptor area (VGDA) functions as the partition table of the LVM, which is stored at the initial position of each PV Once the system starts the LV, the VG is also started, and the VGDA is loaded into a memory. The VGDA assists to identify the practical storage position of the LV. When the system intends to access the storage device, a mapping mechanism built by the VGDA is used to access the practical physical position to execute I/O operations.

However, such a manner in the conventional art still has many defects, and especially, the LV still follows the features of a physical device. When it begins to create a remote volume, a sufficient large storage space is allocated for the LV. No matter the allocated storage space is used or not, it cannot be used by other LVs any more. For example, before one LV is built, it is estimated that the LV needs a storage space supporting 256 GB, but actually only the data of 64 GB is used, the residual spaces are wasted.

Recently, although many logical volume managers support the functions of shrinking and expanding the LV storage space, the function of shrinking the LV storage space is seldom used in practical applications, and the reason lies in that it is difficult to predict whether the residual space is used or not later on. Currently, when the storage space is not sufficiently large, the function of expanding the LV storage space is manually finished by the administrator, which increases the management cost. In addition, the conventional method for expanding the LV space may cause the space to become discontinuous, so as to affect the data writing and reading performance. Therefore, currently, in the conventional LVM technique, there is no such a method for expanding the LV storage space capable of effectively solving the problem that a sufficient large storage space must be allocated when it begins to build the remote volume.

### SUMMARY OF THE INVENTION

In order to solve the problems and defects in the conventional art, the present invention is directed to a method for expanding an LV storage space, which is capable of automatically and timely expanding the LV storage space as data is continuously written into the LV, and effectively solving a problem that the space expansion is discontinuous, such that the influence on the data reading and writing performance caused by the space expansion is reduced to the minimum level.

A method for expanding an LV storage space is provided in the present invention, which includes the following steps.

An LV is created by using an LV manager, and a storage space is allocated for the LV according to a proportion for allocating a subscriber designated space. A continuous expanding space is reserved behind the allocated storage space. It is determined in real time whether the LV storage space needs to be expanded or not during a data writing process till the data has been completely written. When a residual space of the expanding space is lower than a preset proportion value, the data writing process is not finished yet, so that it is determined that the LV storage space needs to be expanded. If the LV storage space needs to be expanded, a size of a new expanding space required to be reserved is obtained by calculating an increment coefficient for space expansion according to a using situation of the previously reserved expanding space, thereby further reserving a continuous expanding space within a space scope managed by the LV manager. If the LV storage space does not need to be expanded, the data is directly written.

To sum up, the present invention has the following efficacies.

The present invention is directed to a method for expanding an LV storage space, which is capable of dynamically expanding the LV storage space as the data is continuously written into the LV, and effectively solving the problem that the space expansion is discontinuous, such that the influence on the data reading and writing performance caused by the space expansion is reduced to the minimum level.

In this manner, when an application finds out an LV of several TBs, the LV may only be allocated with a space of several GBs on the storage system. As the data is continuously written by the application, the space is automatically and timely expanded, so as to realize a hundred percent utilization of the storage space, which not only saves the disk space, but also reduces the management cost. Furthermore, through adopting such a new LVM manner, a distinct beneficial effect may be also achieved upon combining with the remote copy, that is, it only needs to synchronize the practical data, which greatly saves the network bandwidth and storage space.

The method for dynamically expanding the LV storage space of the present invention further has an advantage that the data reading and writing operations are continuous in terms of the address in applications. If each time when the storage space is not sufficient, one or more PEs are expanded once, and the data written by the subscriber at one time may span across several discontinuous expanding spaces, which may influence the data reading and writing performance. In the method for dynamically expanding the LV storage space of the present invention, the continuous expanding space reserved each time can ensure that the data written by the subscriber at one time are continuously expanded in the reserved space.

### BRIEF DESCRIPTION OF THE DRAWINGS

The present invention will become more fully understood from the detailed description given herein below for illustration only, and thus are not limitative of the present invention, and wherein:

FIG. 1 is a flow chart of a method for expanding an LV storage space according to the present invention; and

FIG. 2 is a flow chart of a method for calculating an increment coefficient of space expansion according to the present invention.

### DETAILED DESCRIPTION OF THE INVENTION

The preferred embodiment of the present invention is described below in detail with reference to the accompanying drawings.

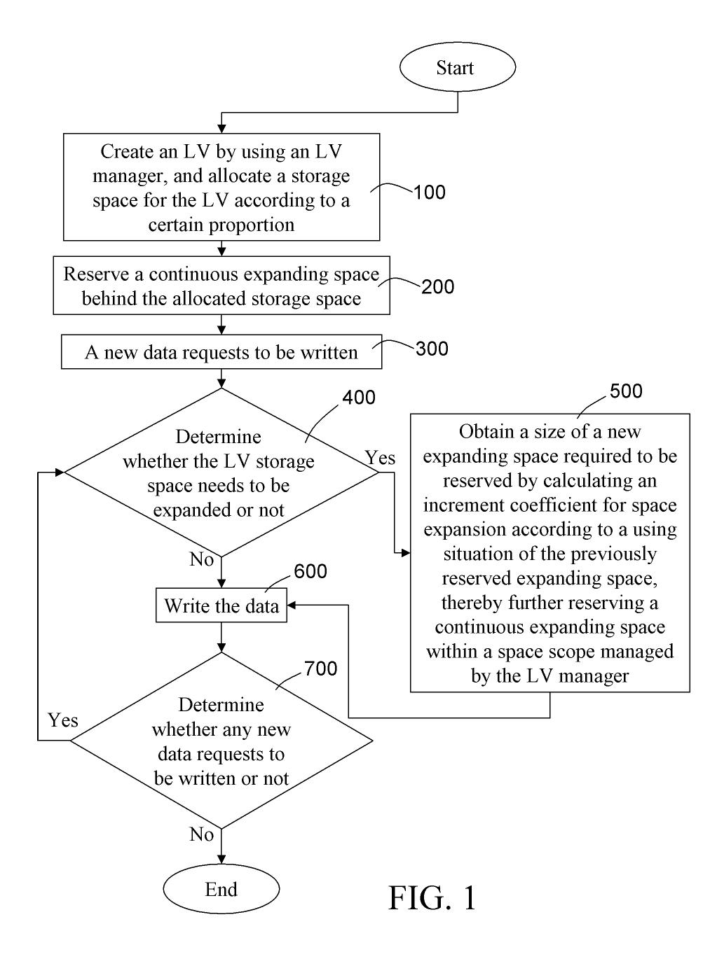

FIG. 1 is a flow chart of a method for expanding an LV storage space according to the present invention. Referring to FIG. 1, the method for dynamically expanding the LV storage space of the present invention includes the following steps.

An LV is created by using an LV manager, and a storage space is allocated for the LV according to a proportion for allocating a subscriber designated space (Step 100), in which the proportion for allocating the subscriber designated space may be set freely by the subscriber or a system administrator, and may also be a system default value.

A continuous expanding space is reserved behind the allocated storage space (Step 200), in which a size of the reserved expanding space at the first time may be set by the system administrator according to requirements.

When a new data requests to be written (Step 300), it is determined whether the LV storage space needs to be expanded or not (Step 400).

If the LV storage space needs to be expanded, a size of a new expanding space required to be reserved is obtained by calculating an increment coefficient for space expansion according to a using situation of the previously reserved expanding space, thereby further reserving a continuous expanding space within a space scope managed by the LV manager (Step 500), and then the data is written (Step 600).

If the LV storage space does not need to be expanded, the data is directly written (Step 600).

It is determined whether any new data requests to be written or not (Step 700). If yes, it returns to Step 400; otherwise, the flow is ended.

When a residual space of the expanding space is lower than a preset proportion value (set by the subscriber or the system administrator according to the requirements), the data writing is not finished yet, so that it is determined that the LV storage space needs to be expanded.

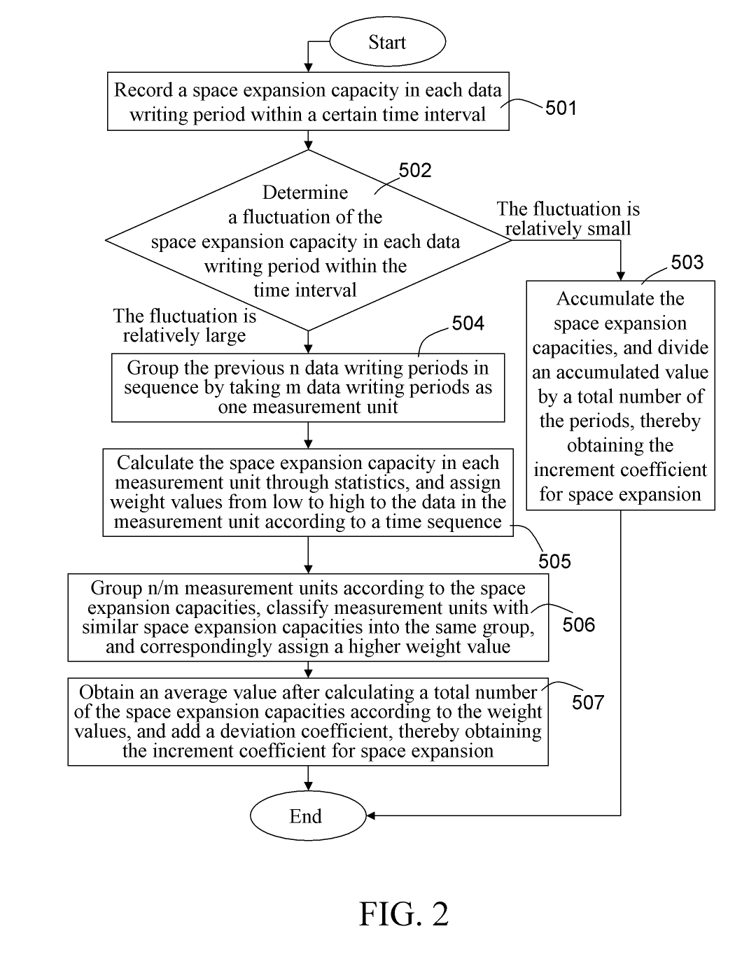

FIG. 2 is a flow chart of a method for calculating an increment coefficient for space expansion according to the present invention. Referring to FIG. 2, the method for calculating the increment coefficient for space expansion according to the present invention includes the following steps.

A space expansion capacity in each data writing period within a certain time interval is recorded (Step 501).

A fluctuation of the space expansion capacity in each data writing period within the time interval is determined (Step 502).

If the fluctuation of the space expansion capacity is relatively small, the space expansion capacities are accumulated, and then an accumulated value is divided by a total number of the periods, thereby obtaining the increment coefficient for space expansion (Step 503).

If the fluctuation of the space expansion capacity is relatively large, the previous n data writing periods are grouped in sequence by taking m data writing periods as one measurement unit (Step 504).

The space expansion capacity in each measurement unit are calculated through statistics, and weight values from low to high are assigned to the data in the measurement unit according to a time sequence (Step 505).

The n/m measurement units are grouped according to the space expansion capacities, in which the measurement units with similar space expansion capacities are classified into the same group, and correspondingly assigned with a higher weight value (Step 506).

An average value is obtained after a total number of the space expansion capacities are calculated according to the weight values, and a deviation coefficient is added, thereby obtaining the increment coefficient for space expansion (Step 507).

The m is a number of data writing periods in which the subscriber requests to ensure that the data is continuously written, and n and m are set by the subscriber or the system administrator according to the calculation requirements, but n shall be evenly divided by m.

The objectives, features, and advantages of the method for expanding the LV storage space of the present invention are described below in detail with the embodiments from four aspects.

1. Creation of the LV

When the subscriber creates an LV, a size of the required LV storage space is designated. The size of the space size is usually the required maximum supporting space estimated by the subscriber. When the LV is created by the LV manager, a certain proportion of the subscriber designated space is allocated. The residual space is automatically expanded as the data is continuously written, which may be at most expanded to the size of the space designated by the subscriber. When the LV is created, the proportion for allocating the subscriber designated space may be set freely by the subscriber or the system administrator. The system administrator may not set such an option, but directly adopting a system default value. For example, the system default value of 5% is set, and when the subscriber designates an LV of 1 TB, a space of approximately 50 GB is allocated for the LV when it is created.

In order to ensure the continuity of the applications, it needs to reserve a continuous expanding space behind the allocated storage space. Thus, when the allocated storage space is used up, it can ensure that the expanding space is allocated on the logically continuous addresses. The expanding space is merely reserved for the LV, instead of acting as the storage space already allocated to the LV. The actually expanded space is calculated into the space already allocated for the LV. The size of the reserved expanding space may be set by the system administrator.

After the reserved expanding space is used up, it needs to reserve another continuous expanding space in the space scope managed by the LV manager. The size of the further reserved expanding space is calculated by using the method for calculating the increment coefficient for space expansion in the present invention, thereby ensuring that the data can be continuously accessed, without reserving an excessively large storage space. It is further illustrated through the above example that, if the subscriber designates the LV of 1 TB, the space of approximately 50 GB is allocated for the LV when it is created and an expanding space of 10 GB is reserved. After the reserved expanding space is used up, a size of a new expanding space required to be reserved is further calculated according to the using situation of the reserved expanding space.

The expanding space served for the LV is still the storage space that is not allocated actually. Therefore, if the storage resources are not sufficient, the system administrator may determine whether the reserved expanding space may be used by other LVs or not.

2. Calculation of the Increment Coefficient for Space Expansion

The data generation and accessing operations usually have one period. For example, as for a data center, one day is taken as a period, and the data access is performed on the data of a certain day or focuses on data of several days.

The space expansion capacity in each period within a certain time interval is recorded.

If the fluctuation of the space expansion capacity in each period is relatively small within such a time interval, the space expansion capacities are accumulated, and the accumulated value is divided by a total number of the periods, thereby obtaining the increment coefficient for space expansion, which indicates an accurate space expansion capacity in one period. By using the increment coefficient for space expansion, the size of the reserved expanding space required to ensure that the data is continuously accessed in one or more subsequent periods can be obtained through calculation.

In addition, if the fluctuation of the space expansion capacity in each period is relatively large in the recorded time interval, in order to ensure that the data is continuously accessed in each period, the expanding space cannot be calculated simply through the above method. Under such a situation, the calculation of the increment coefficient for space expansion depends on two critical factors. First, the space expansion capacity in the latest period greatly affects the calculation of the size of the new reserved expanding space. Second, the space expansion capacities in certain periods are grouped, and the group with largest number of members is the space expansion capacity with the highest occurrence frequency, which also greatly affects the calculation of the size of the subsequently reserved expanding space. The detailed calculation method is, for example, described below. For example, the subscriber requests that the data shall be ensured to be continuously accessed in the subsequent three periods, the space expanding situation in the previous 15 periods is analyzed, so as to determine the size of the expanding space required by the subsequent three periods. The data is grouped in sequence, and 3 periods are taken as one measurement unit, so the previous 15 periods have totally 5 measurement units. The space expansion capacity in each measurement unit is calculated through statistics, and weight values from low to high are assigned to data in the measurement units according to the time sequence. In addition, the 5 measurement units are grouped according to the space expansion capacities, for example, if the space expansion capacities in 2 measurement units are similar to each other, and the space expansion capacities in the other 3 measurement units are quite different, the 2 measurement units with similar space expansion capacities are classified into the same group, and a higher weight value is correspondingly assigned to the 2 measurement units. Then, an average value is obtained after a total number of the space expansion capacities are calculated according to the weight values, and a deviation coefficient is added, thereby obtaining the size of the reserved expanding space required to ensure that the data is continuously written in the subsequent 3 periods.

3. Descriptions of the Automatically Expanding Occasion

In order to ensure that the data is continuously accessed in N periods, under the situation that the space expansion capacity of each period is relatively stable, the new expanding space merely needs to be reserved after the N periods. That's because the reserved continuous expanding space can ensure the continuous expanding of the N periods. When the new expanding space is reserved, it is necessary to calculate the position and size of the new expanding space. Since the continuous address there behind may be occupied by other LVs, it is necessary to calculate the position of the new expanding space, and the size of the new expanding space may be generated through the above calculating method according to the using situation of the previous space expansion capacities. The previously reserved expanding space, which is not used up, is determined to be continuously used by the LV or returned to the LV manager through the policy designated by the system administrator.

In order to avoid an extreme situation that the data amount is occasionally boosted to completely use up the reserved expanding space, in the method for expanding the LV storage space of the present invention, one protection mechanism is added, that is, when the residual space of the reserved expanding space is lower than a certain proportion value and the N periods are not finished yet, a new expanding space is reserved before hand.

4. Description of the Data Continuity

As for the subscriber, the LV storage space is a continuous storage space, which may be continuous or discontinuous in the management layer of the LV manager. In the management layer of the LV manager, the logical addresses are generally assigned to the continuous physical addresses in sequence, so that the space continuity of the management layer of the LV manager can basically ensure the continuity of the physical addresses.

Through the method for expanding the LV storage space of the present invention, although the whole LV space addresses are not continuous any more in the management layer of the LV manager, it can ensure that the space addresses in each data access period are continuous in the management layer of the LV manager. In practical applications, a whole LV is seldom continuously accessed from beginning to end for one time, but generally, the data in a certain period or several periods is continuously accessed. Thus, the method for expanding the LV storage space of the present invention substantially ensures that the data is continuously accessed in each time.

What is claimed is:

1. A method for expanding a logical volume (LV) storage space, comprising:
creating an LV by using an LV manager, and allocating a storage space for the LV according to a proportion for allocating a subscriber designated space;
reserving a continuous expanding space behind the allocated storage space;
determining in real time whether the LV storage space needs to be expanded or not during a data writing process till the data is completely written, wherein when a residual space of the expanding space is lower than a preset proportion value, but the data writing process is not finished yet, it is determined that the LV storage space needs to be expanded;
if the LV storage space needs to be expanded, obtaining a size of a new expanding space required to be reserved by calculating an increment coefficient for space expansion according to a using situation of the previously reserved expanding space, thereby further reserving a continuous expanding space within a space scope managed by the LV manager; and
if the LV storage space does not need to be expanded, directly writing the data.

2. The method for expanding an LV storage space according to claim 1, wherein the process of calculating the increment coefficient for space expansion comprises:
recording a space expansion capacity in each data writing period within a certain time interval;
determining a fluctuation of the space expansion capacity in each data writing period within the time interval; and
if the fluctuation of the space expansion capacity is relatively small, accumulating the space expansion capacities, and dividing an accumulated value by a total number of periods, thereby obtaining the increment coefficient for space expansion.

3. The method for expanding an LV storage space according to claim 2, wherein the process of calculating the increment coefficient for space expansion further comprises:
if the fluctuation of the space expansion capacity is relatively large, grouping previous n data writing periods in sequence by taking m data writing periods as one measurement unit;
calculating the space expansion capacity in each measurement unit through statistics, and assigning weight values from low to high to data in the measurement unit according to a time sequence;
grouping n/m measurement units according to the space expansion capacities, classifying measurement units with similar space expansion capacities into the same group, and correspondingly assigning a higher weight value; and
obtaining an average value after calculating a total number of space expansion capacities according to the weight values, and adding a deviation coefficient, thereby obtaining the increment coefficient for space expansion.

4. The method for expanding an LV storage space according to claim 3, wherein m is a number of data writing periods requested by the subscriber to ensure that the data is continuously written, and n and m are set by the subscriber or a system administrator according to calculation requirements, but n shall be evenly divided by m.

5. The method for expanding an LV storage space according to claim 1, wherein the proportion for allocating the subscriber designated space is set by the subscriber or a system administrator.

6. The method for expanding an LV storage space according to claim 1, wherein the proportion for allocating the subscriber designated space is a system default value.

7. The method for expanding an LV storage space according to claim 1, wherein the size of the reserved expanding space for the first time is set by a system administrator.
